(19) United States
(12) Patent Application Publication
(10) Pub. No.: US 2017/0113227 A1
(43) Pub. Date: Apr. 27, 2017

(54) SHEAR BAR

(71) Applicant: Betek GmbH & Co. KG, Aichhalden (DE)

(72) Inventors: Florian SMEETS, Dossenheim (DE); Ulrich KRAEMER, Wolfach (DE)

(73) Assignee: Betek GmbH & Co. KG, Aichhalden (DE)

(21) Appl. No.: 15/381,323

(22) Filed: Dec. 16, 2016

Related U.S. Application Data
(63) Continuation of application No. PCT/EP2015/063351, filed on Jun. 15, 2015.

(30) Foreign Application Priority Data
Jun. 18, 2014 (DE) 10 2014 108 607.4

(51) Int. Cl. B02C 18/18; B27L 11/00

(52) U.S. Cl. CPC B02C 18/18; B27L 11/005; B02C 2018/188

(57) ABSTRACT

The present invention relates to a shear bar, in particular, for a wood chipper for producing wood chips, having at least one cutting edge formed from a hard material and one support surface leading to the cutting edge, wherein the cutting edge is formed from a plurality of hard material elements arranged side by side along the cutting edge on at least one basic body. A strength-optimized realization with a long service life and a simple assembly is achieved as a result of the hard material elements being fastened on the at least one basic body by means of an adhesive bond.

### CROSS REFERENCE TO RELATED APPLICATIONS

This application is a continuation of International Application No. PCT/EP2015/063351 filed Jun. 15, 2015, which designated the United States, and claims the benefit under 35 USC §119(a)-(d) of German Application No. 10 2014 108 607.4 filed Jun. 18, 2014, the entireties of which are incorporated herein by reference.

### FIELD OF THE INVENTION

The present invention relates to a shear bar, in particular, for a wood chipper for producing wood chips, having at least one cutting edge formed from a hard material and one support surface leading to the cutting edge, wherein the cutting edge is formed from one continuous hard material element or from a plurality of hard material elements arranged side by side along the cutting edge on at least one basic body.

### BACKGROUND OF THE INVENTION

For shredding bio products, for example, from the agricultural or forestry sectors, but also for waste shredding, shredding units are used where rotating cutters are moved past a fixed shear bar and the product is shredded between the rotating cutters and the shear bar. The material to be shredded is fed to the shredding unit by means of a feeder device.

The cutters and the shear bars are exposed to a high level of wear, it being possible to increase the service life significantly by using hard metal. In order to achieve a long service life, DE 2014043009164500 provides a shear bar, in particular, to produce wood chips, which comprises at least one cutting edge formed from a hard material. The hard material elements are joined to the basic body as a result of hard soldering. In order to ensure a stress-optimized design for the benefit of a lower breakage risk, the cutting edge is formed from a plurality of hard material elements arranged side by side along the cutting edge on at least one basic body. The object underlying the present invention is, consequently, to provide a strength-optimized shear bar which has a long service life and is simple to assemble.

### SUMMARY OF THE INVENTION

The object of the present invention is achieved as a result of the hard material elements being fastened to the at least one basic body by means of an adhesive bond.

By means of the adhesive bond, the hard material elements can be fastened to the basic body simply and without heat input in a positive locking manner. In this way, an approximately uniform stress distribution can be achieved without thermal distortion which can occur, in particular, in the case of hard soldering during the cooling operation on account of the different thermal expansion coefficients of the different materials. Thus, expenditure on post-treatment is prevented or at least minimized. In addition, a possible structural change inside the metal as a result of heating the basic body, which is produced, in particular, from a hard material, is inhibited. Consequently, a hardened and tempered steel can also be used for the basic body, the strength characteristics of which are not impaired by the joining process. Consequently, a possible decrease in strength as a result of heat input is prevented, which can reduce a breakage risk on the cutting edges. Adhesive bonds are distinguished by short production times and low production costs along with the above advantages.

An improved hold of the hard material elements on the basic body is achieved as a result of the basic body comprising at least one recess which extends in its longitudinal direction for admitting the hard material elements. In this case, the hard material elements are preferably received in the recess by means of an end portion. The recess facilitates, in particular, the production as the hard material elements can already be aligned therein in a simple manner in the correct position and have taken hold before the adhesive bond is hardened. In addition, as a result of the hard material elements being admitted at least in part into the basic body, a relatively large layer thickness of hard metal can be realized without an excessively large protrusion of material being produced in relation to the basic body. The durability of the cutting edge, which is exposed to a large amount of wear, is able to be extended in this way.

The recess is preferably developed in such a manner that it comprises at least one counter surface which connects to at least one contact surface of the respective hard material element through the intermediary of the adhesive bond. Consequently, the counter surface and the contact surface form a defined adhesive surface which, as regards its development, can be optimized to the stress. Advantageous in this connection are adhesive surfaces that have as large an area as possible and are aligned in such a manner that they are predominantly subjected to shear when the load is as intended. When the shear bar is used as provided, the force acts on the hard material element chiefly perpendicular to a top surface of the basic body. In a preferred orientation, the adhesive surface consequently runs perpendicular or substantially perpendicular to the top surface.

It is advantageous for a high level of strength of the adhesive bond when an adhesive gap, which is situated between the at least one counter surface and the respective contact surface, comprises a gap thickness which is defined by at least one spacer. Thus, the formation of regions with different adhesive film thicknesses is avoided during the adhesive operation. These would cause different, undefined strengths. The named development variant allows for the fixing of a defined adhesive film thickness which is decisive to a defined uniform strength of the adhesive bond. In a preferred manner, the thickness d of the adhesive gap is kept as small as possible, for example 0.05 mm<d <0.5 mm.

The fastening of the respective hard material element to the basic body is facilitated as a result of the spacer being connected in one piece to the hard material element and/or to the basic body. The at least one spacer, in this case, can be realized, for example, in the manner of a pin or a nub. Thus, it is already pre-positioned and does not have to be separately aligned when fastening the hard material element to the basic body. In addition, there is less expenditure on parts.

The recess preferably comprises an attachment portion at its long-sided ends. This facilitates, on the one hand, the admitting of even the hard material elements located on the outer ends of the cutting edge, as a certain free play is provided in this way. On the other hand, it simplifies the production of the recess.

A preferred development variant of the shear bar according to the present invention provides that the recess is delimited on opposite sides by means of counter surfaces, wherein the counter surfaces extend in the longitudinal direction of the basic body. In addition, it is provided in this case that the hard material element is bonded with at least one counter surface by way of the end portion, which is inserted into the recess and is realized as a plug-in attachment. The recess thus secures the hard material element additionally against tipping out forward. This simplifies, in particular, the assembly as the respective hard material element can be inserted into the recess first of all in a self-holding manner by means of its end portion that is realized as a plug-in attachment, until the adhesive bond has hardened.

It has an optimizing effect on costs when the cutting edge is formed by head portions of the hard material elements and when the end portions are set back in relation to the cutting edge transversely with respect to the longitudinal direction of the basic body. A free surface offset to the cutting edge is formed in this manner. The free surface can be formed, for example, by the hard material element itself and/or by the basic body. A possible variant in this case can be in such a manner that allows for space for an edge of the basic body which can be realized simply by the lateral surface of the basic body being lengthened upward in part. The edge can then also comprise a certain wall thickness which almost corresponds to the rear offset of the end portions. In addition, the cross section of the respective hard material element is reduced in the region of the end portion, and as a result its overall volume, which leads to a saving in the material of the cost-intensive hard material. This can occur without impairing the service life of the shear bar, as the material saving is realized on the plug-in attachment which is subjected to less wear, not on the cutting edge which is subjected to heavier wear.

It is expediently provided according to the present invention that the head portions are supported in relation to the basic body indirectly or directly in a region beneath the cutting edge. This produces additional stability as, in this way, force components acting from above on the respective head portion can be compensated by the basic body at least in part, also, in particular, in a positive locking manner. The end portion and/or the at least one spacer can act in this case, for example, in an indirect manner. In addition, the supporting serves for simplified assembly as it is able to hold the hard material element already in position without the adhesive bond when it is admitted into the recess.

For favorable force distribution and secure mounting in the recess, the effect is particularly advantageous when the hard material elements are supported in relation to the basic body by means of a positive locking connection. This can be realized, for example, in the form of a counter surface which extends parallel to a top surface and along the basic body. Such a surface progression is advantageous as it is able to absorb in an effective manner the forces introduced in the load state for the most part from the direction of the top surface.

The shear bar according to the present invention can be formed in a wear-optimized manner by at least one lateral surface of the basic body being set back in relation to a lateral cutting edge portion of the cutting edge which connects indirectly or directly to the cutting edge. Thus, the basic body, which as a rule is produced from less hard material, is protected from excessive wear by the protruding cutting edge.

A saving in cost-intensive hard material whilst retaining the high level of wear resistance is obtained as a result of the contact surface comprising a shoulder which is set back in relation to the cutting edge and extends in the longitudinal direction of the basic body. The shoulder is in such a manner that the contact surface is divided into a region which protrudes somewhat beyond the shoulder and which includes, in particular, the cutting edge, and a region which is set back in relation to the region, by means of which product to be shredded is fed to the cutting edge. The development makes it possible for the required material strength to be applied in the heavily compressively loaded region of the cutting edge. In contrast, the set-back region, which is generally speaking subjected to expansion, can be provided with a thinner hard material application. This serves as a more flexible loading possibility and saves on material.

The top surface of the basic body is preferably covered by a cover plate which is fastened on the top surface of the basic body, in particular, by means of a materially bonded connection, for example, a soldered joint or an adhesive bond. The cover plate ensures, on the one hand, a uniform support surface and protects, on the other hand, the basic body against wear. It is preferably realized from a harder material than the basic body. By the cover plate being fastened to the basic body by means of a materially bonded connection, other fastening means, such as, for example, bores which can weaken the basic body, are not required. Adhesive bonds are preferred compared to soldered joints as described above. Depending on the development of the basic body, soldered joints can also be used in the region of the cover plates without weakening the basic body in a significant manner.

When the hard material elements comprise cover surfaces for the at least partial covering of a top surface of the basic body, this reduces expenditure on parts as there is no need for separate cover plates. Moreover, the cover surfaces can additionally serve as adhesive surfaces, which can additionally stabilize the bond between the corresponding hard material element and the basic body.

In a further development of the present invention, it is provided that at least one surface of the hard material element and/or at least one corresponding surface on the basic body is treated mechanically, thermally and/or chemically. The surfaces obtain, for example, by means of etching, a roughened surface structure which promotes the arranging of the corresponding surfaces one on top of another by means of an adhesive bond. Mechanical or thermal roughening would also be conceivable here, for example, as a result of a blasting procedure.

A further advantageous development of the present invention provides that the shear bar comprises at least one recess and/or at least one break-through, wherein the hard material element covers, at least in part, edge regions of the at least one recess and/or of the at least one break-through. An advantageous application is provided for sieve surfaces which are used for shredding and/or sieving solid ground material. In this case, the ground material, on account of its own weight or as a result of corresponding acceleration, impacts on the edges of the recesses or break-throughs, is shredded and sieved. For protection against wear, the edge regions of the recesses or of the break-throughs are covered with hard metal elements which are arranged side by side.

Furthermore, it is provided in a further advantageous development of the present invention that the shear bar is arrangeable in a static or dynamic manner with reference to the cutting edge of a further cutting element or that the cutting edge of the further cutting element is arrangeable in a static or dynamic manner with reference to the shear bar. For example, the development forms are used in drum shredders, the drum housing being lined with a plurality of strip-shaped shear bars, past which the further cutting element scrapes and shreds the material. It is provided in this case that the drum housing or the further cutting element or the housing and the cutting element carry out a rotational movement.

### BRIEF DESCRIPTION OF THE DRAWINGS

The present invention is explained in more detail below by way of exemplary embodiments with reference to the drawings, in which:

FIG. 1 shows a perspective view of a shear bar with two cutting edges;

FIG. 2a shows the shear bar according to FIG. 1 along the cutting sequence marked by way of II-II in FIG. 1;

FIG. 2b shows a detail according to FIG. 2a with a hard material element of the shear bar;

FIG. 3 shows a detail according to FIG. 1 with the attachment of a cutting edge;

FIG. 4a shows a sectional representation of a shear bar with hard material elements and a cover plate;

FIG. 4b shows a detail according to FIG. 4a with a hard material element of the shear bar;

FIG. 5a shows a sectional representation of a shear bar with hard material elements and a cover plate;

FIG. 5b shows a detail according to FIG. 5a with a hard material element of the shear bar;

FIG. 6 shows a detail of the shear bar realized according to FIG. 5a with the attachment of a cutting edge;

FIG. 7a shows a sectional representation of a shear bar with hard material elements and a cover plate;

FIG. 7b shows a detail according to FIG. 7a with a hard material element of the shear bar; and

FIG. 8 shows a detail of the shear bar realized according to FIG. 7a with the attachment of a cutting edge.

### DETAILED DESCRIPTION OF THE INVENTION

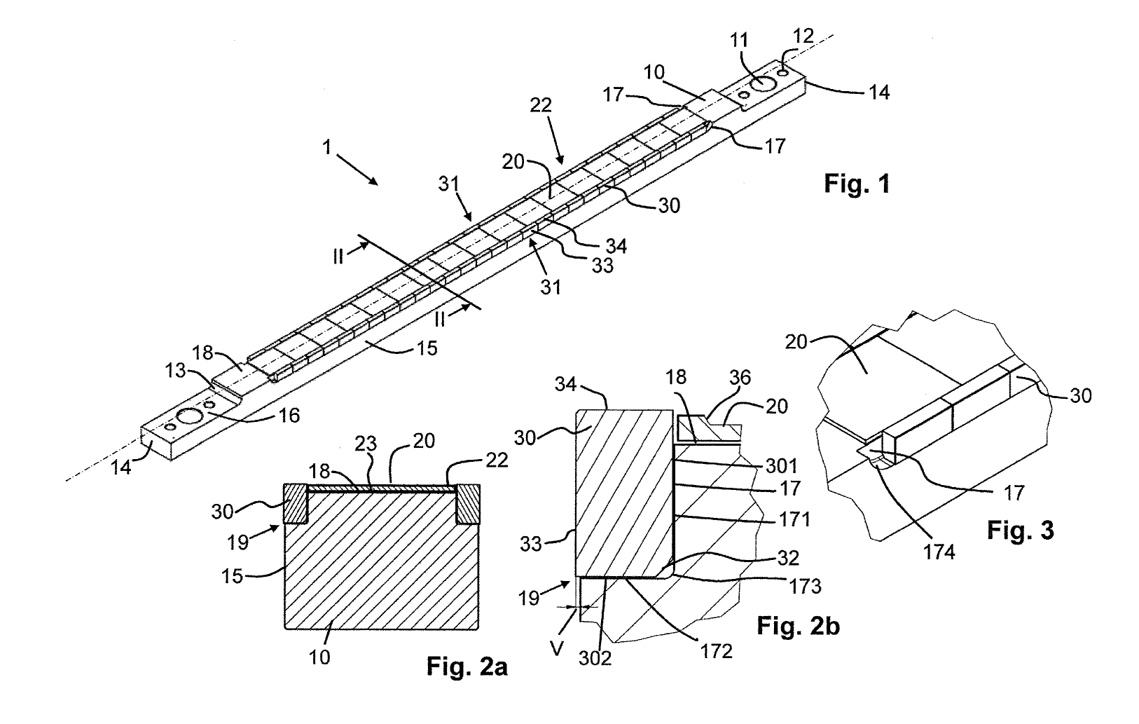

FIG. 1 shows a shear bar 1 with an elongated basic body 10, which comprises a rectangular cross section in its basic form. It is produced, for example, from a hardened and tempered steel. On its longitudinal ends, which close off in each case by way of end surfaces 14, mounting surfaces 16 are provided with one bore 11 each and two threaded receiving means 12 for receiving fastening means, preferably screws. The mounting surfaces 16 are cut back over a radius 13 in relation to the basic form of the basic body 10, and thus allow secure introduction into a mounting which is not shown here. As an alternative to this, the shear bar 1 can also comprise several basic bodies 10 which can be additionally mounted on a carrier.

The basic body 10 comprises two cutting edges 31 which extend in the longitudinal direction. These are formed by a plurality of hard material elements 30 admitted into two recesses 17. As an alternative to this, one continuous hard material element, in particular, a continuous hard material element that can be produced in a simple and dimensionally accurate manner, can also be used. This can be realized in particular as an extruded section. Several cover plates 20 are arranged for instance in the axial region of the cutting edges 31 on a top surface 18 of the basic body 10 in such a manner that they form a contiguous part of a support surface 22. In this case, the abutting edges between the cover plates 20 are placed axially offset with respect to the abutting edges between the individual hard material elements 30 in order to prevent erosions. The part of the support surface 22 formed by the cover plates 20 merges toward the outside surfaces of the top surface 18 into a part formed by the cutting edges 34 which at the same time provides the top cutting edge portions 34 of the cutting edges 31. The top cutting edge portions 34 are supplemented in each case by a lateral cutting edge portion 33 of the respective cutting edge 31 which extends thereto at an angle preferably within the range of between ≧60° and ≦90°. A lateral surface 15 of the basic body 10 connects in each case to the lateral cutting edge portions.

Details regarding the hard material elements 30 and the cover plates 20 as well as their arrangement on the basic body 10 can be seen from FIG. 2a and 2b. The cover plate 20 rests by way of a bottom surface 23 on the top surface 18 of the basic body 10. It is fastened by means of an adhesive bond 19 or a soldered joint. As can be seen more precisely in FIG. 2b, the hard material element 30 comprises an almost rectangular cross section with a chamfer 32, the outside surfaces forming the lateral or the top cutting edge portion 33 or 34. The oppositely situated surfaces in each case form a first or a second contact surface 301 or 302, by way of which the hard material element 30 is admitted into the recess 17. The recess 17 comprises a counter cross section corresponding to the hard material element 30 with a first and second counter surface 171 and 172 which extend in their alignments preferably parallel to the lateral surface 15 or top surface 18 of the basic body, as well as a longitudinal radius 173. The longitudinal radius 173 facilitates, together with the chamfer 32, the correct admission of the hard material element 30 in the recess 17.

With the cutting edges 31 in the mounted state shown in FIG. 1, the contact surfaces 301, 302 are joined in each case to the first or the second counter surface 171 or 172 of the recesses 17 as a result of an adhesive bond 19. It would also be conceivable for just one surface pair, preferably the first contact and counter surface 301 and 171, to be joined by means of an adhesive bond 19. As a result of the just two contact and counter surfaces arranged at right angles to one another, the realization shown provides a variant that is particularly simple to produce.

As shown in FIG. 2b, the hard material element 30 is arranged in relation to the basic body 10 in such a manner that the lateral cutting edge portion 33 of the hard material element 30 is offset forward in relation to the lateral surface 15 of the basic body 10 by a projection V. In the reverse manner, therefore, the lateral surface 15 is set back in relation to the cutting edge, as a result of which the lateral surface 15 is protected from abrasion. The cover plate 20 comprises a shoulder 36 which extends in the longitudinal direction of the basic body close to the hard material element 30.

FIG. 3 shows an attachment portion 174 of the recess 17 which is realized with a rounding. The hard material elements 30 which close off the cutting edge 31 toward the outside are also easily able to be inserted into the recess 17 by means of the attachment portion. The geometry of the closing hard material elements 30 can be adapted to the rounding and, for example, fill out the same. Precise positioning can then be performed and the length of the cutting edge can be enlarged. The rounding of the attachment portion 174 additionally provides stress reduction and consequently a diminished risk of breaking.

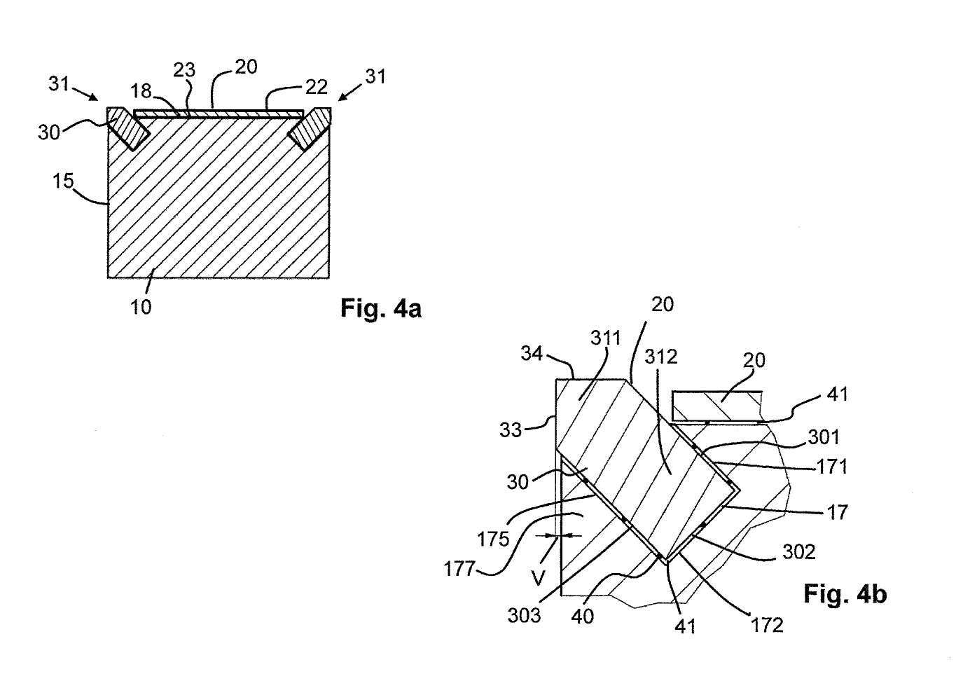

FIG. 4a and 4b show an alternative development variant of the hard material elements 30 and correspondingly of the recess 17. In this connection, the longitudinally extending recess 17 is inserted at an angle into the basic body as a type of groove. This type of recess 17 creates an edge 177 which comprises a third counter surface 175 which extends parallel to the first counter surface 171 located opposite it. The first, second and a third contact surface 301, 302, 303 of the hard material element 30 delimit an end portion 312, which is realized as a type of plug-in attachment. Consequently, the hard material element 30 can already be inserted in a positive locking manner into the recess 17 without an adhesive bond 19. The three contact surfaces 301, 302, 303 of the hard material element 30 are joined to the basic body 10 by means of the adhesive bond 19 by way of the three counter surfaces 171, 172, 175, which causes a high degree of stability on account of an enlarged adhesive surface. Just as the cover plate 20, the hard material element 30 can comprise spacers 40 which ensure a defined thickness of the adhesive gap 41. It is also conceivable for the contact surfaces 301, 303 to be at an angle to one another such that a conical end portion 312 is produced. This is then simple to mount in the recess 17, which is also adapted and realized in a conical manner.

Above the end portion 312 of the hard material element 30 is situated the head portion 311 thereof which comprises the lateral and top cutting edge portions 33, 34 which are preferably arranged at right angles to one another. A good cutting performance with at the same time a high level of stability is produced when the enclosed angle between the cutting edge portions 33, 34 is chosen to be within the range of ≧60° and ≦90°. The head portion 311 projects out of the recess 17 in such a manner that it forms the cutting edge 31. In this case, the lateral surface 15, in turn, is set back in relation to the lateral cutting edge portion 33 by V such that the lateral surface is protected from wear. The cover plate 20 is set back in relation to the top cutting edge portion 34 for forming a shoulder 36.

As regards its stability and simplified assembly, the realization variant shown in FIGS. 4a and 4b provides a more favorable but also complex embodiment compared to the first variant. In this case, it is nevertheless relatively simple to produce as a result of the recess 17 which is formed as a type of groove. Stress optimization or improved wear characteristics could be achieved in this variant, for example, by chamfering or rounding of the edges. In particular, the transition between the counter surfaces 171, 172 and/or 175 could be formed by means of radii or chamfers and/or the top closure of the edge 177 could be rounded or chamfered.

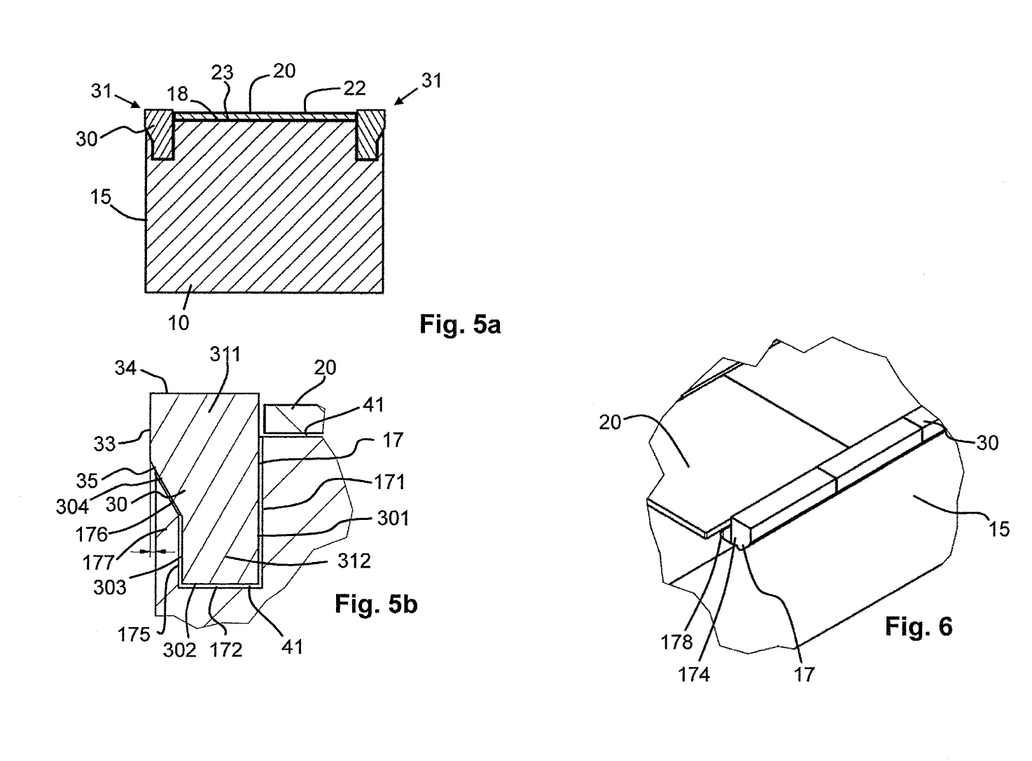

FIGS. 5a and 5b show a further realization variant of a shear bar according to the present invention. In this connection, the first or the second counter surface 171 or 172 of the recess 17 preferably run at least approximately parallel to the lateral surface 15 or to the top surface 18 of the basic body 10. In addition, the recess 17 is delimited by an outwardly extending edge 177 which comprises the third counter surface 175. The third counter surface 175 preferably runs parallel or approximately parallel to the first counter surface 171 which is arranged opposite it. A fourth counter surface 176 connects to the third counter surface 175 of the recess 17, by means of which fourth counter surface the edge 177 slants upward. The hard material element 30 comprises four corresponding contact surfaces 301, 302, 303 and 304 on its end portion 312 which is realized correspondingly as a plug-in attachment. In this case, the fourth contact surface 304 is realized as an inclination 35 such that the third contact surface 303 is set back in relation to the lateral cutting edge attachment 33. In this way, space is created for the edge 177 which, in the development of this type, can simply be pulled upward proceeding from the lateral surface 15. At the same time, the lateral cutting edge portion 33 is offset forward in relation to the edge 177, which has a favorable effect on the wear resistance as here, a large wear volume is provided in the head portion 311. In addition, as a result of the inclination 35 the end portion 312 has a smaller cross section than if it were to extend at the same height as the head portion 311.

In the example shown in FIGS. 5a and 5b, the end portion 312 of the second contact surface 302 rests in a positive locking manner on the second counter surface 172. The adhesive bond 19 exists between the first, third and fourth contact and counter surfaces 171 and 301, 175 and 303 as well as 176 and 304, which is not directly recognizable in the figures. The cover plate 20 is set back in relation to the top cutting edge portion 34 to form a shoulder 36. FIG. 6 shows a further variant of an attachment portion 174, with a rounding 178.

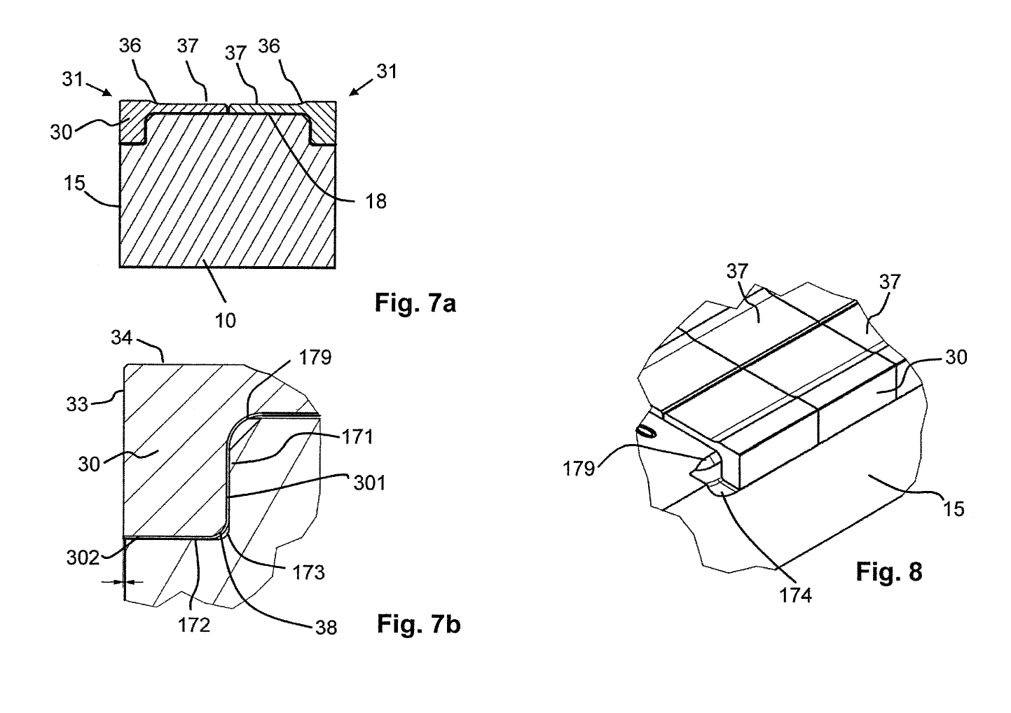

FIGS. 7a and 7b show a development form according to the present invention, in which the hard material elements 30 comprise cover surfaces 37 which replace the cover plates 20 as regards their function. The transition from the hard material element 30 into the cover surface 37 is realized in a stress-optimized manner by means of a round transition 179. The attachment of the round transition 179 in the region of the attachment portion 174 is shown in FIG. 8.

As shown in FIG. 7a, the cover surfaces 37 of two oppositely situated hard material elements 30 contact one another in the center of the top surface 18 of the basic body 10 and consequently, in conjunction with the top cutting edge portion 34, cover the full width of the top surface 18. The bottom surface 23 of the cover surface 37 is additionally utilized, in this case, as an adhesive surface. It would also be conceivable for it simply to rest thereon and the adhesive bond to be realized in the recess 17 by means of at least one of the contact surfaces 301, 302.

The described embodiments according to the present invention clarify some of the diverse development possibilities for an adhesive bond of the shear bar 1. It is thus able to be realized in a strength-optimized manner without additional bores in the region of the cutting edge.

1. A shear bar comprising at least one cutting edge formed from a hard material and one support surface leading to the cutting edge, wherein the cutting edge is formed from one continuous or a plurality of hard material elements arranged side by side along the cutting edge on at least one basic body, wherein the continuous hard material element or at least part of the hard material elements are fastened on the at least one basic body by an adhesive bond.

2. The shear bar as claimed in claim 1, wherein the basic body comprises a least one recess which extends in its longitudinal direction for admitting the hard material element or elements, wherein the hard material elements are received in the recess by an end portion.

3. The shear bar as claimed in claim 2, wherein the recess comprises at least one counter surface which connects to at least one contact surface of the respective hard material element through the adhesive bond.

4. The shear bar as claimed in claim 3, wherein an adhesive gap, which is situated between the at least one counter surface and the respective contact surface, comprises a gap thickness which is defined by at least one spacer.

5. The shear bar as claimed in claim 4, wherein the spacer is connected in one piece to the hard material element and/or to the basic body.

6. The shear bar as claimed in claim 2, wherein the recess comprises an attachment portion at its long-sided ends.

7. The shear bar as claimed in claim 2, wherein the recess is delimited on opposite sides by counter surfaces and a further counter surface, wherein said counter surfaces extend in the longitudinal direction of the basic body and wherein the hard material elements are bonded with at least one counter surface by the end portions, which are inserted into the recess and are realized as a plug-in attachment.

8. The shear bar as claimed in claim 1, wherein the cutting edge is formed by head portions of the hard material elements and wherein the end portions are set back in relation to the cutting edge transversely with respect to the longitudinal direction of the basic body.

9. The shear bar as claimed in claim 8, wherein at least part of the head portions are supported in relation to the basic body indirectly or directly in a region beneath the cutting edge.

10. The shear bar as claimed in claim 1, wherein at least part of the hard material elements are supported in relation to the basic body by a positive locking connection.

11. The shear bar as claimed in claim 1, wherein at least one region of a lateral surface of the basic body is set back in relation to a lateral cutting edge portion of the cutting edge which connects indirectly or directly to the cutting edge.

12. The shear bar as claimed in claim 1, wherein the support surface comprises a shoulder which is set back in relation to the cutting edge and extends in the longitudinal direction of the basic body.

13. The shear bar as claimed in claim 1, wherein a top surface of the basic body is covered by a cover plate which is fastened on the top surface of the basic body by an adhesive bond or a soldered connection.

14. The shear bar as claimed in claim 1, wherein at least part of the hard material elements comprises cover surfaces for the at least partial covering of a top surface of the basic body.

15. The shear bar as claimed in claim 1, wherein at least one surface of the hard material element and/or at least one corresponding surface on the basic body is treated mechanically, thermally, and/or chemically.

16. The shear bar as claimed in claim 1, wherein the shear bar comprises at least one recess and/or at least one break-through, wherein the hard material element covers, at least in part, edge regions of the at least one recess and/or of the at least one break-through.

17. The shear bar as claimed in claim 1, wherein the shear bar is arrangeable in a static or dynamic manner with reference to the cutting edge of a further cutting element.

18. The shear bar as claimed in claim 17, wherein the cutting edge of the further cutting element is arrangeable in a static or dynamic manner with reference to the shear bar.

19. A wood chipper comprising the shear bar of claim 1.
